(19) United States
(12) Patent Application Publication
(10) Pub. No.: US 2005/0092185 A1
(43) Pub. Date: May 5, 2005

(54) Device for providing a drink from extracts, in particular tea extracts, and cover and container for use in such a device

(75) Inventor: Miha Klinar, Ljubljana (SI)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: MAGNA TERRA B.V., SE Groningen (NL)

(21) Appl. No.: 10/713,573

(22) Filed: Oct. 31, 2003

(51) Int. Cl. A23F 3/00

(52) U.S. Cl. 99/279

(57) ABSTRACT

The invention relates to a device for providing a drink from extracts, in particular tea extracts, comprising at least one container for an extractable mixture which is at least partially permeable to liquid and which container comprises at least two container parts pivotally connected to each other, a cover connected to the container, which cover comprises at least two cover parts pivotally connected to each other, wherein each cover part is pivotally connected to a separate container part. The invention also relates to a cover for use in such a device. The invention further relates to a container for use in such a device.

The invention relates to a device for providing a drink from extracts, in particular tea extracts, comprising at least one container for an extractable mixture which is at least partially permeable to drink, and which container comprises at least two container parts pivotally connected to each other, a cover connected to the container, which cover comprises at least two cover parts pivotally connected to each other, wherein each cover part is pivotally connected to a separate container part. The invention also relates to a cover for use in such a device. The invention further relates to a container for use in such a device.

A device as stated in the preamble is known from the prior art. The American patent U.S. Pat. No. 5,318,786 thus describes such a device, wherein the cover is formed by a hook-like element for fastening the device to an external object, such as a liquid container. The cover is connected to a container for extracts such that the container is pivotable between a position of use, wherein the container is positioned for immersion in a liquid, and a transporting position, wherein the container is partially enclosed by the hook-like cover. In the transporting position the effectively occupied volume is minimized, which can generally result in a reduction of the transport and/or storage costs of the device. As well as the said advantage, the known device also has drawbacks. One drawback of the known device is that after immersion in a liquid the container can be pivoted from the position of use to the transport position (or storage position), wherein there is a comparatively high risk of a user for instance being scalded by liquid that has not yet cooled and/or being soiled or stained by liquid in which extracts are dispersed dripping out of the container.

The invention has for its object, while maintaining the advantage of the prior art, of providing an improved device with which a used device can be displaced in simple and hygienic manner.

The invention provides for this purpose a device of the type stated in the preamble, characterized in that the container is connected to the cover such that the device is pivotable between a folded-out active position, in which a substantial part of the container lies at a distance from the cover, and a folded-up non-active position, in which the container is at least substantially enclosed by the cover. The device according to the invention has the relevant advantage that, after use of the device, i.e. after temporary immersion in a liquid, the device can be removed from the liquid without a user being able to scald himself in simple manner with relatively hot liquid, and-without the user being stained or soiled by extracts dispersed in the liquid. The device according to the invention moreover makes it possible to squeeze out the liquid taken up by the container by applying an external load to the cover in the folded-up position, without the user usually coming into contact with the expressed liquid. Optionally heated water is preferably applied as liquid. It is however equally conceivable to apply other, optionally heated (non-alcoholic) drinks. Tea leaves are preferably applied herein as extractable mixture. It is however also possible to envisage the use of a different extractable mixture with which a drink can be provided from extracts.

In a preferred embodiment each cover part is connected, at least close to a side remote from the adjacent cover part, to a part of the container part at least close to a side remote from an adjacent container part. A significant advantage of this preferred embodiment is that the container is then folded out to the maximum in the folded-out position, wherein the mutual distance between a first pivot axis forming part of the container and a second pivot axis forming part of the cover can be maximized. The danger of contact between the user and the liquid during use of the device will thus be minimized.

The container is preferably manufactured from a flexible material. A container can thus be applied which is for instance manufactured from textile, paper or flexible plastic. A flexible material generally allows simple expressing of the liquid after use of the device, whereby the liquid content in the container can be minimized in simple and hygienic manner after use of the device.

Each container part is preferably provided with at least one compartment for the mixture. The distribution of the quantity of extractable mixture over a plurality of compartments generally has the advantage that the area/volume ration of the mixture can generally be increased, whereby extraction of extracts from the extractable mixture during immersion of the container in the liquid can take place in relatively rapid and intensive manner.

In a preferred embodiment at least one cover part is provided with an incision extending to a side of the cover part for the purpose of positioning the device. It is thus possible to attach the device during the extraction process to an external object, preferably a liquid container. In a particular preferred embodiment the incision is given an at least partial hook-like form. The incision has on the one hand the advantage that no recess, or at least no substantial recess, has to be arranged, whereby the cover retains its firmness and the above stated advantages of the invention, while on the other hand the hook shape of the incision enables a stable positioning of the device.

In another preferred embodiment the container is at least substantially non-permeable to the extractable mixture. It is thus possible to prevent, or at least counter, a part of the mixture entering the drink, which is generally undesirable. Since the container must however be permeable to liquid, the container has to be provided with passage openings (or meshes), which have to be dimensioned such that they do not allow through (a substantial part of) the mixture.

The cover and the container are preferably connected releasably to each other. Such a preferred embodiment has the advantage that the cover can be given a durable form and can thus be reused a number of times. After use of the device the container can be disconnected from the cover and replaced by a new, unused container. The container is preferably provided with coupling means for co-action with counter-coupling means forming part of the cover. The coupling means can herein be embodied for instance as two strips, these strips being arranged on the separate container parts. The counter-coupling means are then formed for instance by two counter-strips provided with a channel for receiving a part of the strips. It is however also possible to realize a different coupling between the container and the cover. It is for instance thus possible to envisage an adhesive connection, a velcro tape connection, a mutual mechanical fastening and a clamping connection.

In another preferred embodiment the container is provided with a closable filling opening for feed respectively discharge of the extractable mixture. Such a preferred embodiment has the advantage that the container can take a durable, although preferably flexible form, wherein only the partly extracted mixture is replaced after use of the device.

The invention also relates to a cover for use in such a device. The cover can herein take a durable and a non-durable form. The cover is preferably provided with one or more characters to promote specific services or goods.

The invention further relates to a container for an extractable mixture for use in such a device.

The invention can be elucidated with reference to non-limitative embodiments as shown in the following figures, in which:

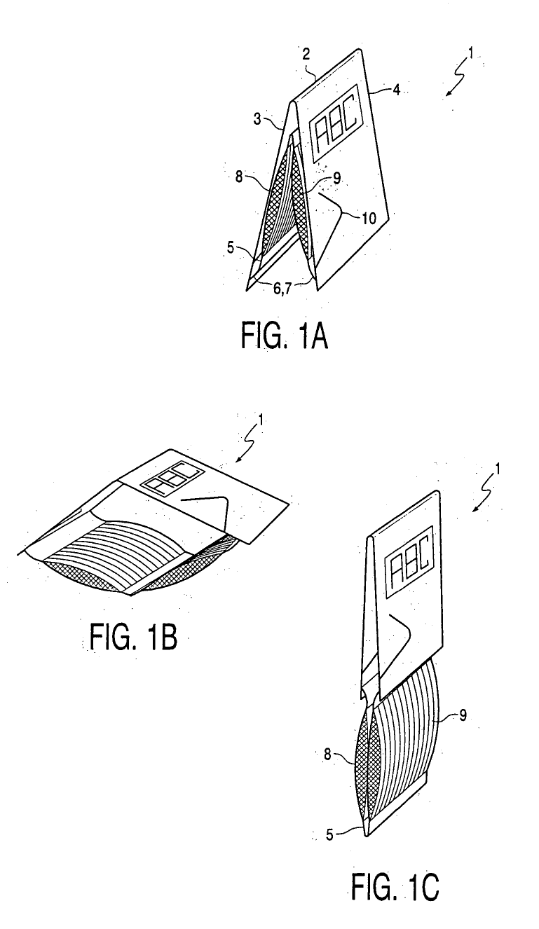

FIG. 1a shows a perspective view of a preferred embodiment of a device according to the invention in a folded-up situation,

FIG. 1b is a perspective view of the device of FIG. 1a in a transition situation,

FIG. 1c is a perspective view of the device of FIG. 1a in a folded-out situation,

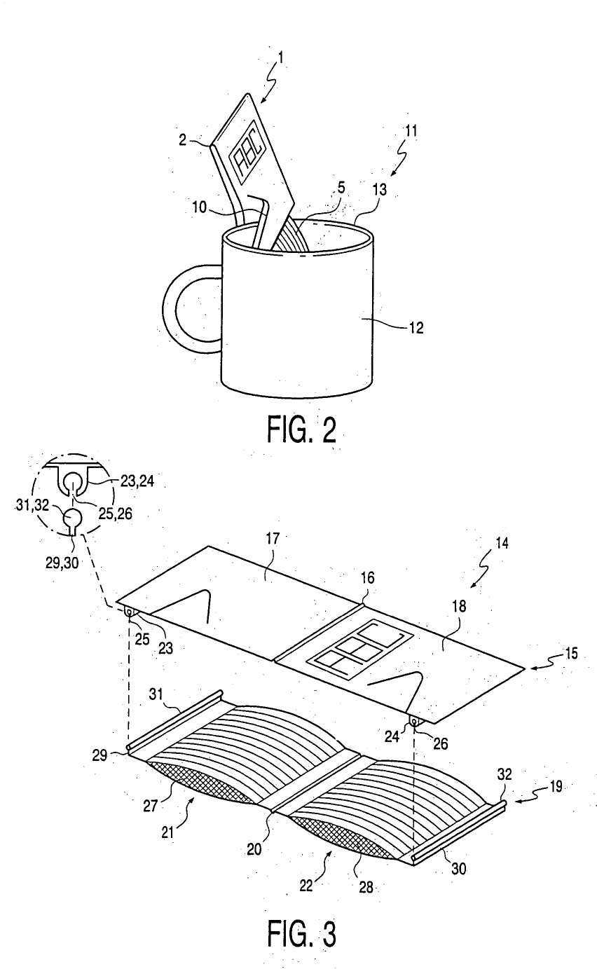

FIG. 2 is a perspective view of an assembly of the device of FIG. 1 and a drinking cup, and

FIG. 3 is a perspective view of another preferred embodiment, with exploded parts, of a device according to the invention.

FIG. 1a shows a perspective view of a preferred embodiment of a device 1 according to the invention in a folded-up situation. Device 1 comprises a cover 2, which cover 2 is constructed from two cover parts 3, 4 connected pivotally to each other and a container 5 for tea leaves connected pivotally to the two cover parts 3, 4. Container 5 is provided with two container parts 6, 7 connected pivotally to each other, which container parts 6, 7 are each provided with a compartment 8, 9 for the tea leaves. Cover 2 is preferably made from reinforced paper or cardboard, whereby cover 2 functions as gripping member for a user. Cover 2 is provided with an imprint, for instance to advertise particular goods or services. At least one cover part 4 is provided with a hook-shaped incision 10 for stable positioning of device 1 on for instance a rim of a liquid container. The hook-shaped incision 10 also has the advantage—in addition to stable positioning of the device—that device 1 does not hook onto for instance an adjacent device, or at least not readily. Such hooking of devices to each other will generally occur when incisions of other, for instance linear, form are applied. It will therefore be possible for removal of an individual device from a package of devices to generally take place in simple and problem-free manner with use of the device 1 shown in FIG. 1a (provided with the hook-shaped incision 10). Container 5, or at least the compartments 8, 9, are manufactured from a flexible material permeable to drink, such as for instance from textile, paper or perforated plastic. The folded-up position of device 1 shown in FIG. 1a is in the first place very suitable for transport and storage of device 1, since the volume taken up is relatively small. In addition, the device 1 has the advantage that after use the device 1 can be returned to the shown folded-up position without the user therein being scalded and/or coming into contact at all with a drink held in container 5. It is noted that other mixtures can also be applied as extractable mixture as well as tea leaves. Using device 1 it is thus possible to envisage adding for instance soup extracts, coffee extracts or vanilla extracts to a drink instead of tea extracts. It is noted that cover 2 here has a rectangular form. It is however also conceivable to design cover 2 in other manner, for instance as oval shape or round, wherein it is essential that cover 2 at least substantially encloses container 5 in the folded-up position as according to FIG. 1a.

FIG. 1b shows a perspective view of device 1 of FIG. 1a in a transition situation. The transition situation is a situation between the folded-up situation of FIG. 1a and the folded-out situation of FIG. 1c.

FIG. 1c shows a perspective view of device 1 of FIG. 1a in a folded-out situation. In the folded-out situation the device 1 is suitable for providing a drink with extracts by immersing (a part of) the device 1 in the drink. Container 5 can thus be positioned in a drink, whereby compartments 8, 9 can be immersed in the drink, whereupon extraction from the mixture enclosed in compartments 8, 9 can take place.

FIG. 2 shows a perspective view of an assembly 11 of device 1 of FIG. 1 and a drinking cup 12. Device 1 is positioned in stable manner on a rim 13 of drinking cup 12 using hook-shaped incision 10 that only container 5 can make contact with drink present in drinking cup 12. Cover 2 will therefore substantially not come into contact with the drink and thus remain at least substantially dry, which is advantageous for the user after use of device 1.

FIG. 3 shows a perspective view of another preferred embodiment, with exploded parts, of a device 14 according to the invention. The device comprises a cover 15, which cover 15 comprises two cover parts 17, 18 mutually connected for pivoting on a first pivot axis 16, and a container for an extractable mixture 19, which container 19 comprises two container parts 21, 22 mutually connected for pivoting on a second pivot axis 20. Each cover part 17, 18 is provided with a strip 23, 24 on a part remote from the first pivot axis 16, wherein each strip 23, 24 is provided with a channel 25, 26. Each container part 21, 22 is provided with a compartment 27, 28, which compartments 27, 28 are filled with an extractable mixture. Each container part 21, 22 is moreover provided with a counter-strip 29, 30 on a part remote from the second pivot axis 20, which counter-strips 29, 30 are provided with a thickened outer end 31, 32. Strips 23, 24 are adapted for co-action with counter-strips 29, 30, whereby a releasable pivotable coupling can be realized between cover 15 and container 19. It is thus possible for instance to give the cover 15 a durable form, wherein container 19 is replaced after use by an unused, new container.

1-12. (canceled)

13: A device for providing a drink from extracts, comprising:
at least one container for an extractable mixture which is at least partially permeable to liquid and which container comprises at least two container parts pivotally connected to each other,
a cover connected to the container, which cover comprises at least two cover parts pivotally connected to each other, wherein each cover part is pivotally connected to a separate container part,
wherein the container is connected to the cover such that the device is pivotable between a folded-out active position, in which a substantial part of the container lies at a distance from the cover, and a folded-up non-active position, in which the container is at least substantially enclosed by the cover.

14: The device as claimed in claim 13, wherein each cover part is connected, at least close to a side remote from the adjacent cover part, to a part of the container part at least close to a side remote from an adjacent container part.

15: The device as claimed in claim 13, wherein the container is manufactured from a flexible material.

16: The device as claimed in claim 13, wherein each container part is provided with at least one compartment for the mixture.

17: The device as claimed in claim 13, wherein at least one cover part is provided with an incision extending to a side of the cover part for the purpose of positioning the device.

18: The device as claimed in claim 17, wherein the incision is given an at least partial hook-like form.

19: The device as claimed in claim 13, wherein the container is at least substantially non-permeable to the mixture.

20: The device as claimed in claim 13, wherein the cover and the container are connected releasably to each other.

21: The device as claimed in claim 20, wherein the container is provided with coupling means for co-action with counter-coupling means forming part of the cover.

22: A cover for use in a device as claimed in claim 20.

23: A container for an extractable mixture for use in a device as claimed in claim 20.
